(19) United States
(12) Patent Application Publication
(10) Pub. No.: US 2008/0248445 A1
(43) Pub. Date: Oct. 9, 2008

(54) Dental abrasive strip

(76) Inventor: Daniel SungYul Kim, Vancouver, WA (US)

Correspondence Address: Daniel Sung Yul Kim, 215 DuBois Court, Vancouver, WA, 98661, US

(21) Appl. No.: 11/732,815

(22) Filed: Apr. 5, 2007

(51) Int. Cl. A61C 3/06

(52) U.S. Cl. 433/142

(57) ABSTRACT

A abrasive dental filing strip coated with some superfine abrasive material, especially but not limited to diamond dust like particles, or alternatively a sharp cutting system along the lateral surface, and having cutting edge like serrated or saw tooth along the longitudinal edge or edges.

### BACKGROUND OF THE INVENTION

This invention relates to dental abrasive strip, more particularly to a dental abrasive strip that is a thin strip coated with superfine abrasive material or has sharp cutting edges of perforations of this strip for efficient filing of the interproximal area and fitting of dental crowns, bridges, onlays or inlays. This abrasive strip has serrated edges that aid to insert this abrasive strip into the Interproximal space that has tight proximal contact.

A method employed for fitting dental crowns, bridges, onlays and inlays, herein referred to generally as restorations, is the stand alone use of a metal abrasive strip coated with some superfine abrasive material. The metal abrasive strip is inserted in the interproximal space between the dental restoration and the adjacent teeth to file down the proximal contact surface of the crown for an accurate fit. Since the space between the tooth and the crown, bridge, onlay, and inlay must not be too close nor too spaced apart the practitioner must file increments at a time. These steps are repeated until the desired distance between the tooth and the restoration is achieved. Because the filing strip is extremely thin, narrow, and malleable, it is difficult to insert the abrasive strip into the tightly contacted or bonded Interproximal space.

In order to solve the existing problems with the above methods for Interproximal grinding and adjustment between restorations and teeth, it is the object of the present invention to provide saw teeth along the edges of the strip that aid to insert the strip into the Interproximal space effectively.

### SUMMARY OF THE INVENTION

The main object of the present invention is to provide the cutting edge of saw teeth along the edges of the filing strip. The cutting edges of saw teeth along the edge of the filing strip aids a abrasive strip to facilitate an easy sawing back and forth movement and to cut into the tight or bonded Interproximal space efficiently and effectively to grind between teeth and the crown, bridge, onlay or inlay for an accurate fitting. It is difficult to insert a abrasive strip into a tight or bonded Interproximal space, because a abrasive strip is extremely thin, narrow and malleable.

The above and other objects, features, and advantages of the present invention will be fully understood from the following description considered in connection with the accompanying drawings included.

### BRIEF DESCRIPTIONS OF THE DRAWINGS

FIG. 1 is a perspective view of a preferred dental abrasive strip according to the present invention.

FIG. 2 is a horizontal front view of preferred dental abrasive dental strip shown in FIG. 1 of the present invention.

FIG. 3 is an alternate of the filing strip with plain lateral surface with abrasive particles attached to saw tooth of cutting edge of the present invention.

FIG. 4 is an alternate of the filing strip with multiple sharp edged perforations along the lateral surface of the present invention.

FIG. 5 is an elevational view depicting the insertion of the abrasive strip interproximally.

### DETAILED DESCRIPTION OF THE INVENTION

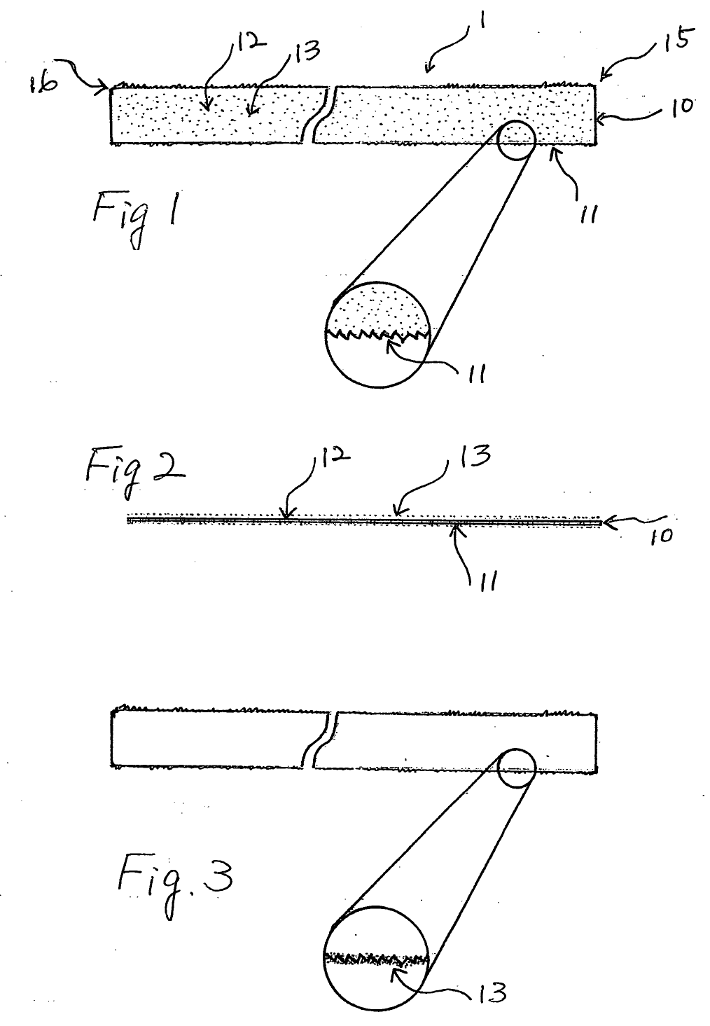

The dental abrasive strip 1 shown as preferred abrasive dental strip in FIGS. 1 and 2, comprises of basic strip component 10 made of a hard material, not limited to but like stainless steel. The basic strip component has a cutting edge 11, including but not limited to saw teeth or serrated system provided along the longitudinal edge. The strip has lateral surfaces 12 coated with superfine abrasive particles 13.

The one or both lateral sides 12 of the filing strip 1 are coated with some superfine abrasive material 13, especially but not limited to diamond dust-like particles. The filing strip 1 is of the appropriate thickness to be inserted into the interproximal area between teeth and/or crowns, bridges, onlays, or inlays, generally referred to as restorations in FIG. 5.

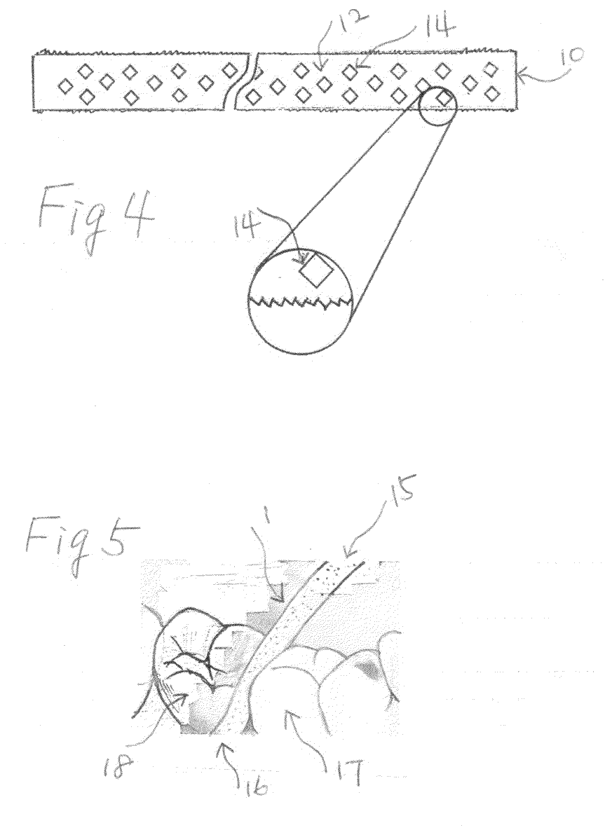

Additionally in FIG. 3 the serrated edge of the abrasive dental strip 1 is coated with superfine abrasive particles 13 to accelerate cutting efficiency the dental bonding material between teeth and dental restoration.

Additionally in FIG. 4 the basic strip 10 has multiple sharp edged perforations 14 along the lateral surface 12 of the filing strip 10.

The dental abrasive strip 1 is used in the following manner as depicted in FIG. 5. Initially the user holds the endings 15 and 16 of the abrasive filing strip 1 with both hands placing opposable fingers on each flat surface area and aligns the filing strip 1 portion above the interproximal space between the tooth 17 and the restoration 18. The user may, with applied pressure, commence a back and forth sawing motion with the slight movement of the opposable fingers or wrist to file down the proximal surface to create the appropriate interproximal distance.

It should be noted that while the abrasive dental strip 1 maintains sufficient tension to create a rigid surface, the slight malleability of the strip 1 still allows the user to manipulate it with directional pressure applied to form to any concavities along interproximal surfaces of teeth. As the abrasive filing strip 1 is pulled back and forth between the area of proximal surface contact, the abrasive lateral surface 12 of the filing strip gently removes enamel or restoration material in whatever conservative or aggressive increments desired by the user in relation to the repetitive filing motions and applied pressure.

It will be understood that each of the elements described above, or two or more together may also find useful application in other types of methods differing from the types described above.

While the present invention has been described with reference to specific embodiments, it should be understood that it is not intended to be limited to the details described above. Those skilled in the art understand that various alterations, modifications, substitutions, or omissions of the forms and details of the preferred embodiment may be made without departing from the spirit and scope of this prevent invention. Therefore, it should be clearly understood that the descriptions and illustrations of the preferred embodiment are only to facilitate a clearer understanding of the invention and not used to unduly limit the scope of the present invention.

I claim:

1. A serrated abrasive dental strip, which comprises:
(A) A thin strip with abrasive material coated, serrated, or saw teeth along the longitudinal edges, and
(B) the strip coated with a superfine abrasive material, or alternatively having a sharp cutting edge system, or sharp-edged perforations along the lateral surface,
